(19) United States
(12) Patent Application Publication
(10) Pub. No.: US 2014/0063250 A1
(43) Pub. Date: Mar. 6, 2014

(54) APPARATUS AND METHOD OF PROCESSING IMAGE OF VEHICLE AND SYSTEM FOR PROCESSING IMAGE OF VEHICLE USING THE SAME

(71) Applicant: Hyun Jin PARK, Seoul (KR)

(72) Inventor: Hyun Jin PARK, Seoul (KR)

(21) Appl. No.: 13/658,124

(22) Filed: Oct. 23, 2012

(30) Foreign Application Priority Data
Sep. 6, 2012 (KR) 10-2012-0098988

(51) Int. Cl. H04N 7/18

(52) U.S. Cl. 348/148; 348/E07.085

(57) ABSTRACT

Disclosed are an apparatus and a method of processing an image of a vehicle capable of reducing a load of transmitting an image by setting a region of interest and transmitting only a part corresponding to the region of interest, and a system for processing an image of a vehicle using the same.

### CROSS-REFERENCE TO RELATED APPLICATIONS

This application claims priority to and the benefit of Korean Patent Application No. 10-2012-0098988 filed in the Korean Intellectual Property Office on Sep. 6, 2012, the entire contents of which are incorporated herein by reference.

### TECHNICAL FIELD

The present invention relates to an apparatus and a method of processing an image of a vehicle and a system for processing an image of a vehicle using the same. More particularly, the present invention relates to an apparatus and a method of processing an image of a vehicle capable of reducing a load of transmitting an image by setting a region of interest and transmitting only a part corresponding to the region of interest, and a system for processing an image of a vehicle using the same.

### BACKGROUND ART

A system for processing an image of a vehicle includes a lane departure warning system (LDWS), a forward collision warnings system (FCWS), a high beam assist system (HBAS), or an around view monitoring system (AVMS).

The system for processing an image of a vehicle receives images collected by a camera and extracts a necessary region of interest from the received camera images to generate information.

Each system receives all images collected by the camera in order to generate necessary information, so that a transmission bandwidth may be limited and an over load and the like may be generated, and thus information may not be generated in real time.

When the camera compresses and transmits a HD high resolution image to the system for processing an image of a vehicle, a problem may also occur in that a load of a CPU of the system for processing an image of a vehicle increases in order to decompress the image.

### SUMMARY OF THE INVENTION

The present invention has been made in an effort to provide an apparatus and a method of processing an image of a vehicle capable of decreasing a quantity of data transmitted and reducing a load of a CPU by transmitting only an image corresponding to a region of interest required by the apparatus for processing an image of a vehicle, and a system for processing an image of a vehicle using the same.

An exemplary embodiment of the present invention provides an apparatus for processing an image of a vehicle, including: a region of interest setter configured to set a region of interest that is a necessary region for generating specific information in images collected by cameras; a region of interest transmitter configured to transmit information on the set necessary region to the cameras; an image of interest receiver configured to receive images corresponding to the region of interest from the cameras; and an information generator configured to generate information by using the image corresponding to the region of interest received by the image of interest receiver.

The number of cameras may be at least two or more, the region of interest setter may set the region of interest for each camera, and the image of interest receiver may receive only the images corresponding to the region of interest for the respective cameras among the images collected by the respective cameras from the respective cameras.

The image received by the image of interest receiver may include information on a time at which the camera collects the image.

The image received by the image of interest receiver may include information on a time at which the camera collects the image, and the information generator may synthesize the images having the same information on a time included in the images among the received images when generating the information by synthesizing the received images.

The information generated by the information generator may be at least one among lane departure information, an inter-vehicle distance from a front vehicle, information on a risk of forward collision with another vehicle or a pedestrian, high beam assist information, information on a neighboring area of a vehicle, information on backward parking assistance, and information on a following vehicle.

Another exemplary embodiment of the present invention provides a system of processing an image for a vehicle, including: at least one or more cameras configured to photograph an external side of a vehicle and collect image information; and a vehicle image processing apparatus configured to transmit information on a necessary region among the image information collected by the camera to the camera.

The camera may include an image extractor configured to extract the information on the necessary region from the collected image information by using the information on the necessary region transmitted from the vehicle image processing apparatus.

The camera may further include an extracted image transmitter configured to transmit the image information extracted by the image extractor to the vehicle image processing apparatus, and the vehicle image processing apparatus may include an information generator configured to generate information by using the extracted image information.

When the number of cameras is at least two or more, the vehicle image processing apparatus may transmit information on each necessary region to each of the cameras, and each of the cameras may extract the image of the necessary region from the respective collected image information by using the respective received information on the necessary region and transmits the extracted image to the vehicle image processing apparatus, and the vehicle image processing apparatus may generate information by synthesizing the extracted image information.

The vehicle image processing apparatus may provide the information on the necessary region among the image information collected by the camera periodically, aperiodically, or once.

Yet another exemplary embodiment of the present invention provides a method of processing an image of a vehicle, including: a region of interest setting operation of setting information on a necessary region among images collected by cameras; a region of interest transmitting operation of transmitting information on the set necessary region to the cameras; an image extracting operation of extracting an image corresponding to the set necessary region from the images collected by the cameras; an image of interest receiving operation of receiving the extracted images from the cameras; and an information generating operation of generating information by using the images received in the image of interest receiving operation.

The number of cameras may be at least two or more, and in the region of interest setting operation, the information on the necessary region may be set for each camera, and in the image of interest receiving operation, only an image of the necessary region for each camera among the images collected by the respective cameras may be received from each of the cameras.

In the information generation operation, the information may be generated by synthesizing the images received in the image of interest receiving operation.

The image received in the image of interest receiving operation may include information on a time at which the camera collects the image.

The image received in the image of interest receiving operation may include information on a time at which the camera collects the image, and in the information generating operation, when the information is generated by synthesizing the received images, the images having the same information on a time included in the images among the received images may be synthesized.

According to the exemplary embodiments of the present invention, a quantity of data transmitted is decreased, so that it is possible to transmit data by using a smaller network bandwidth.

According to the exemplary embodiments of the present invention, a region of interest may be changed in real time according to a change in a neighboring environment or an intention of a user, so that various functions may be performed in one apparatus for processing an image of a vehicle.

According to the exemplary embodiments of the present invention, when a high resolution image is compressed and transmitted, only a region of interest is compressed and transmitted, so that a load of a CPU for decompression may be reduced.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram of a vehicle image processing system according to an exemplary embodiment of the present invention.

FIG. 2 is a block diagram of a vehicle image processing system according to another exemplary embodiment of the present invention.

FIG. 3 is a diagram of an example in which a vehicle image processing system according to the present invention is used.

FIG. 4 is a diagram of another example in which a vehicle image processing system according to the present invention is used.

FIG. 5 is a diagram of yet another example in which a vehicle image processing system according to the present invention is used.

FIG. 6 is a flowchart of a vehicle image processing method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. In the following description and the accompanying drawings, the substantially same elements are denoted by the same reference numerals, so that the repeated description will be omitted. In describing the present invention, when it is determined that detailed description relating to well-known functions or configurations may make the subject matter of the present disclosure unnecessarily ambiguous, the detailed description will be omitted.

It should be understood that when one constituent element referred to as being “coupled to” or “connected to” another constituent element, one constituent element can be directly coupled to or connected to the other constituent element, but intervening elements may also be present. In contrast, it should be understood that when one constituent element is “directly coupled to” or “directly connected to” another constituent element, there are no intervening element present.

In the present specification, singular expressions include plurals expressions unless they have definitely opposite meanings. In the present application, it will be appreciated that terms “comprises” and “comprising” are intended to designate the existence of constituent elements, steps, operations, and/or components described in the specification, and do not exclude a possibility of the existence or addition of constituent elements, steps, operations, and/or components.

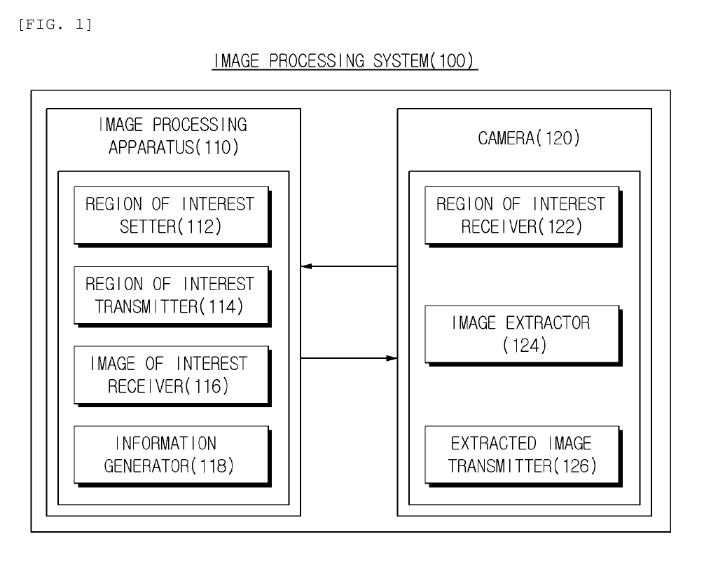

FIG. 1 is a block diagram of a vehicle image processing system according to an exemplary embodiment of the present invention.

Referring to FIG. 1, a vehicle image processing system 100 includes a vehicle image processing apparatus 110 and a camera 120.

The vehicle image processing apparatus 110 is an apparatus for processing an image in order to generate a necessary image of a vehicle. An example of the vehicle image processing apparatus 110 included in a vehicle includes various vehicle image processing apparatuses 110, such as a lane departure warning system (LDWS), a forward collision warnings system (FCWS), a high beam assist system (HBAS), or an around view monitoring system (AVMS).

The aforementioned respective vehicle image processing apparatuses 110 have respective purposes, and receive images collected by the camera 120 from the camera 120 included in the vehicle and process an image for the achievement of the purpose to generate information.

In describing the present invention, the vehicle image processing apparatuses 110 require images for achieving the purposes, and the images are referred to as regions of interest.

The vehicle image processing apparatus 110 according to the present invention may limit images received from the vehicle image processing apparatus 110 and the camera 120 to parts of regions of interest in consideration of a narrow transmission bandwidth of the vehicle, a CPU processing rate, or real-time performance.

Specifically, the vehicle image processing apparatus 110 may include a region of interest setter 112, a region of interest transmitter 114, an image of interest receiver 116, and/or an information generator 118.

The region of interest setter 112 may set a region of interest to be used for generating information required by the vehicle image processing apparatus 110.

For example, when the vehicle image processing apparatus 110 generates information on lane departure warnings, a region of interest of an image is a region in which a lane may be recognized. The region in which a lane may be recognized may be a part except for a region hidden by the vehicle in a lower image in respect to a central portion of the image of the front camera 120 of the vehicle.

For another example, when the vehicle image processing apparatus 110 generates information on an around view monitoring, a region of interest of an image may each be of a front-side image, a back-side image, a left-side image, and a right-side image close to the vehicle.

For another example, when the vehicle image processing apparatus 110 generates information on forward collision warnings, a region of interest of an image may be an image of a front central portion.

The region of interest setter 112 may set a region of interest to be used for generating necessary information in advance similarly to the examples.

When the number of cameras 120 included in the vehicle is plural, the region of interest setter 112 may set different regions of interest for the respective cameras 120 considering photography positions of the corresponding cameras 120.

When the number of vehicle image processing apparatuses 110 is plural, the region of interest setter 112 may be included in each of the vehicle image processing apparatuses 110. The respective region of interest setters 112 may set different regions of interest according to information generated in the respective vehicle image processing apparatuses 110 and the necessary regions of interests. The set different regions of interest may partially overlap each other.

When the number of pieces of the information generated in the one vehicle image processing apparatus 110 is plural, the number of regions of interest may be plural.

The preset region of interest may be changed according to performance of the vehicle, a driving environment of the vehicle, or an intention of a user. The region of interest setter 112 may reset a region of interest by wiredly or wirelessly receiving information about setting of a region of interest.

The region of interest transmitter 114 transmits the region of interest set by the region of interest setter 112 to the camera 120 included in the vehicle.

When the number of cameras 120 is plural, the region of interest transmitter 114 may transmit a region of interest set for each camera 120 to each camera 120.

The region of interest transmitter 114 may periodically or aperiodically transmit the region of interest to the camera 120, and when there is no change in the region of interest set by the region of interest setter 112, the region of interest transmitter 114 may transmit the region of interest only first one time at the time of initialization or an operation of the camera 120.

When the region of interest set by the region of interest setter 112 is changed, the region of interest transmitter 114 may transmit the changed region of interest to the camera 120. An example of a case in which the region of interest is changed may include a case in which a user arbitrarily changes a region of interest, a region of interest is changed according to a preset configuration due to a change in a driving environment of the vehicle, or a case in which a function of the vehicle image processing apparatus 110 is changed.

The region of interest transmitter 114 may transmit information on the region of interest even when the camera 120 makes a request for information on the region of interest.

When the operation of the vehicle image processing apparatus 110 is stopped or it is not necessary to generate information, the region of interest transmitter 114 may transmit, to the camera 120, information indicating that there is no region of interest or a signal indicating that it is not necessary to transmit image information.

That is, the camera 120 may continuously transmit an image until the camera 120 receives the signal indicating that it is not necessary to transmit image information after receiving the information on the region of interest from the region of interest transmitter 114. Otherwise, the camera 120 may continuously transmit an image or transmit an image for a predetermined time until the camera 120 receives a separate signal after receiving the information on the region of interest from the region of interest transmitter 114 one time.

Otherwise, in a case where the region of interest transmitter 114 periodically transmits the information on the region of interest, when the camera 120 fails to receive the information on the region of interest for a predetermined time, the camera 120 may stop transmitting an image to the vehicle image processing apparatus 110.

The image of interest receiver 116 receives an image of interest from the camera 120.

The image of interest refers to an image of a part corresponding to the region of interest in the photographed image.

The image of interest receiver 116 receive the image of interest from at least one camera 120, and the camera 120 transmits only the image of the part corresponding to the region of interest in the entire photographed image, so that a burden of a network bandwidth is decreased.

When the received image of interest is compressed and transmitted, the image of interest receiver 116 may decompress the compressed image of interest. The image of interest receiver 116 receives data in which only the image corresponding to the region of interest is compressed and decompresses the received compressed data, so that the vehicle image processing system 100 or the vehicle image processing apparatus 110 according to the present invention reduce a decompression time and reduce a load of a CPU, compared to a case in which data in which all images photographed by the camera 120 are compressed is received and decompressed.

The information generator 118 generates necessary information by using the image of interest received from the image of interest receiver 116. The necessary information may be information related to the driving of the vehicle.

Specifically, the information related to the driving of the vehicle generated by the information generator 118 may be different according to the purpose of the vehicle image processing apparatus 110. The vehicle image processing apparatus 110 may generate various information, such as information related to lane departure warnings, information on a distance from a front vehicle, information on a risk of forward collision with an obstacle, such as another vehicle or a pedestrian, high beam assist information, information on a neighboring area of a vehicle, information on backward parking assistance, or information on a following vehicle, for various purposes of convenient and safe driving and preventing an accident of the vehicle.

That is, the information related to the driving of the vehicle necessary for the achievement of the aforementioned purposes may be generated in the information generator 118.

The necessary information may be set in advance, and may be changed according to a driving environment, an intention of a user, or a change in a system. One vehicle image processing apparatus 110 may have two or more purposes, and thus the number of pieces of information to be generated may be two or more. The two or more pieces of information to be generated may need to be simultaneously generated or be sequentially generated.

The information generator 118 may generate the necessary information by using an extracted image received from an extracted image transmitter 126 of the camera 120 to be described below, or when the number of received extracted images is plural, the information generator 118 may generate the necessary information by synthesizing the plurality of extracted images.

The camera 120 is installed in the vehicle to photograph an external or internal side of the vehicle, and extracts an image corresponding to the region of interest from the photographed information and transmits the extracted image to the vehicle image processing apparatus 110.

Specifically, the camera 120 may include a region of interest receiver 122, an image extractor 124, and/or an extracted image transmitter 126.

The region of interest receiver 122 receives the region of interest transmitted from the region of interest transmitter 114.

The image extractor 124 extracts an image corresponding to the region of interest from the image photographed by the camera 120 by using the region of interest received in the region of interest receiver 122.

Specifically, the image extractor 124 extracts a region corresponding to the region of interest from the image photographed by the camera 120. A crop function and the like may be used for a method of the extraction.

The image extractor 124 may specifically compress the extracted region. The compression method may compress the extracted region by employing one of various codec, such as MJPEG and H.264.

The extracted image transmitter 126 transmits the image extracted by the image extractor 124 to the vehicle image processing apparatus 110. The transmitted image may be in a compressed state.

The number of cameras 120 may be two or more, and when the number of cameras 120 is plural, the respective cameras 120 may receive the regions of interest from the vehicle image processing apparatus 110, extract the images by using the received regions of interest, and transmit the extracted images to the vehicle image processing apparatus 110.

When the extracted image transmitter 126 of each camera 120 transmits the extracted image to the vehicle image processing apparatus 110, the extracted image transmitter 126 may include information related to a time in the extracted image and transmit the extracted image. When the information generator 118 of the vehicle image processing apparatus 110 receives the extracted image from the two or more cameras 120 and generates the information by synthesizing the received extracted images, the information generator 118 may perform the synchronization by using the information related to the time.

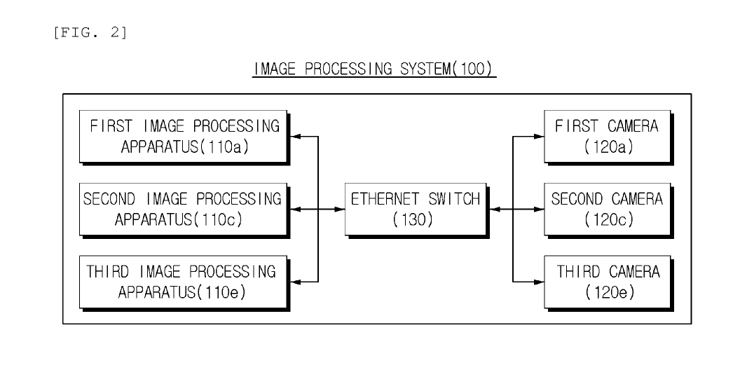

FIG. 2 is a block diagram of a vehicle image processing system according to another exemplary embodiment of the present invention.

Referring to FIG. 2, a vehicle image processing system 100 according to another exemplary embodiment includes a plurality of vehicle image processing apparatuses 110, a plurality of cameras 120, and an Ethernet switch 130.

In FIG. 2, an example of the plurality of vehicle image processing apparatuses 110 includes three vehicle image processing apparatuses 110, that is, a first image processing apparatus 110a, a second image processing apparatus 110c, and a third image processing apparatus 110e. In FIG. 2, an example of the plurality of cameras 120 includes three cameras 120, that is, a first camera 120a, a second camera 120c, and a third camera 120e.

Each of the first image processing apparatus 110a, the second image processing apparatus 110c, and the third image processing apparatus 110e may include a region of interest setter 112, a region of interest transmitter 114, an image of interest receiver 116, and/or an information generator 118.

Each of the first camera 120a, the second camera 120c, and the third camera 120e may include a region of interest receiver 122, an image extractor 124, and/or an extracted image transmitter 126.

The first image processing apparatus 110a, the second image processing apparatus 110c, and the third image processing apparatus 110e may generate different information for different purposes.

The first camera 120a, the second camera 120c, and the third camera 120e may be attached at different positions of the vehicle to photograph different parts. The first camera 120a, the second camera 120c, and the third camera 120e may have different angles of view, photographed widths, or resolution of the camera 120.

Each of the vehicle image processing apparatuses 110 sets a region of interest necessary for a purpose thereof and generation of information for each camera 120 and transmits the set region of interest to each camera 120.

The Ethernet switch 130 may perform time synchronization and real-time data transmission, and may use an audio video bridge (AVB) technology for the time synchronization.

The camera 120 receives information on various regions of interest from each vehicle image processing apparatus 110, extracts a part corresponding to each region of interest from the photographed image, and transmits the extracted part through the Ethernet switch 130.

Each vehicle image processing apparatus 110 receives the part corresponding to the region of interest from each camera 120, synthesizes the received part, and generates the necessary information.

In the vehicle image processing system 100 according to the present invention, a quantity of data transmitted is decreased, so that it is possible to transmit data by using the smaller network bandwidth.

The vehicle image processing system 100 according to the present invention may change a region of interest in real time according to a change in a neighboring environment or an intention of a driver, so that one vehicle image processing apparatus 110 may perform various functions.

The vehicle image processing system 100 according to the present invention compresses and transmits only a region of interest when compressing and transmitting a high resolution image, so that a load of a CPU for decompression may be reduced.

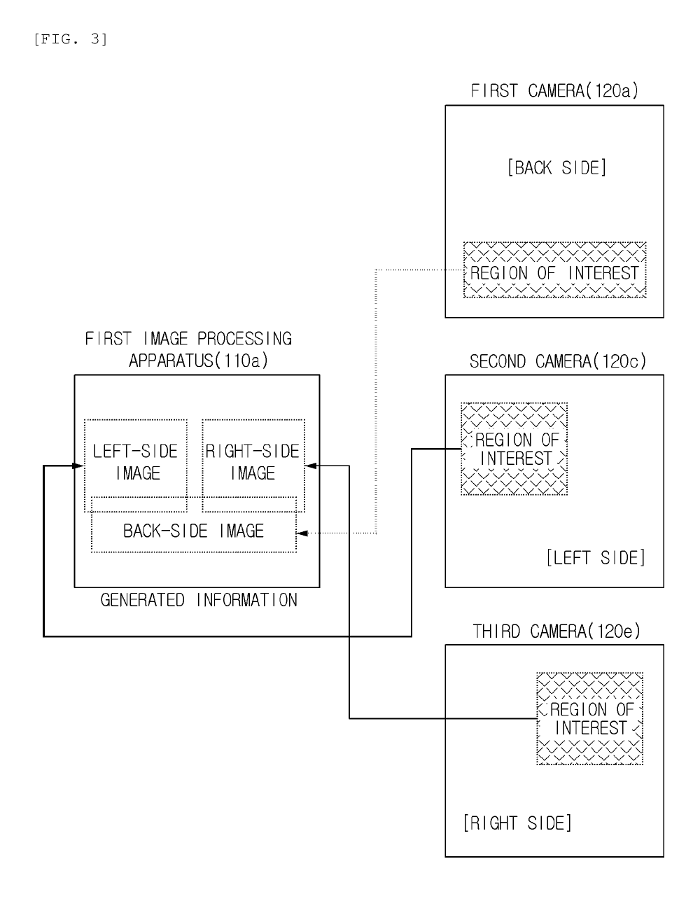

FIG. 3 is a diagram of an example in which a vehicle image processing system according to the present invention is used.

Referring to FIG. 3, FIG. 3 illustrates an example in which a vehicle image processing system 100 including one vehicle image processing apparatus 110 and three cameras 120 generates information.

It is assumed that the one vehicle image processing apparatus 110 is a first image processing apparatus 110a, and the three cameras 120 are the first camera 120a, the second camera 120c, and the third camera 120e.

It is assumed that a purpose of the first image processing apparatus 110a is generation of an image for backward parking assistance, and necessary images in this case are set as a back image of a vehicle, a left-side image of a vehicle, and a right-side image of a vehicle. The setting may be performed by the region of interest setter 112 of the first image processing apparatus 110a, and the setting may be changed as described above.

An image including a back side of the vehicle may be photographed by the first camera 120a, an image including a left side of the vehicle may be photographed by the second camera 120c, and an image including a right side of the vehicle may be photographed by the third camera 120e.

The region of interest transmitter 114 of the first image processing apparatus 110a transmits a region of the back side of the vehicle to the first camera 120a as the region of interest, a region of the left side of the vehicle to the second camera 120c as the region of interest, and a region of the right side of the vehicle to the third camera 120e as the region of interest.

The first camera 120a, the second camera 120c, and the third camera 120e extract images of parts corresponding to the respective received regions of interest and transmit the extracted images to the first image processing apparatus 110a through the Ethernet switch 130. Time information may be included in the transmitted data for synchronization.

The first image processing apparatus 110a may generate an image for the backward parking assistance by synthesizing the images transmitted from the first camera 120a, the second camera 120c, and the third camera 120e.

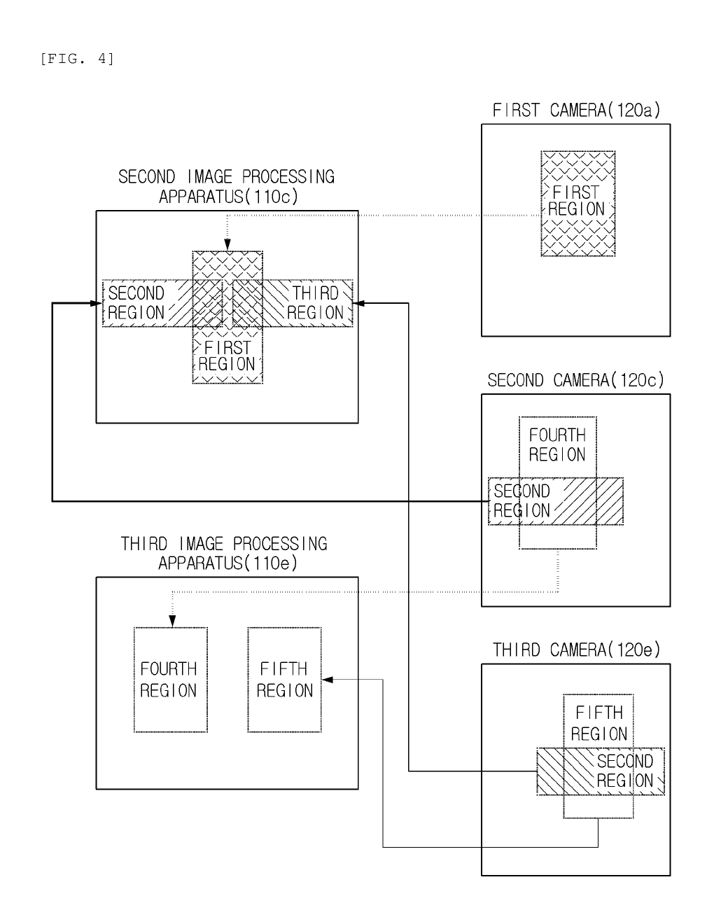

FIG. 4 is a diagram of another example in which a vehicle image processing system according to the present invention is used.

Referring to FIG. 4, a vehicle image processing system 100 according to another exemplary embodiment of the present invention includes two vehicle image processing apparatuses 110 and three cameras 120.

It is assumed that the two vehicle image processing apparatus 110 are a second image processing apparatus 110c and a third image processing apparatus 110e, and the three cameras 120 are the first camera 120a, the second camera 120c, and the third camera 120e.

The second image processing apparatus 110c requires a first region, a second region, and a third region in order to generate necessary information. That is, the regions of interest set in the region of interest setter 112 of the second image processing apparatus 110c become the first region, the second region, and the third region.

The third image processing apparatus 110e requires a fourth region and a fifth region in order to generate necessary information. That is, the regions of interest set in the region of interest setter 112 of the third image processing apparatus 110e become the fourth region and the fifth region.

The first camera 120a photographs an image including the first region, and the second camera 120c photographs an image including the second region and the fourth region. The third camera 120e photographs an image including the third region and the fifth region.

The first camera 120a may extract only the first region corresponding to the received region of interest from the photographed image and transmit the extracted first region to the second image processing apparatus 110c. The first camera 120a may compress and transmit the image when transmitting the extracted image.

The second camera 120c may extract the second region corresponding to the received region of interest from the photographed image and transmit the extracted second region to the first image processing apparatus 110a, and may extract the fourth region and transmit the extracted fourth region to the third image processing apparatus 110e.

The third camera 120e may extract the third region corresponding to the received region of interest from the photographed image and transmit the extracted third region to the second image processing apparatus 110c, and may extract the fifth region and transmit the extracted fifth region to the third image processing apparatus 110e.

The image of interest receiver 116 of the second image processing apparatus 110c receives the images of the first region, the second region, and the third region, and decompresses the images when the received images are compressed. The information generator 118 of the second image processing apparatus 110c generates the necessary information by synthesizing the images of the first region, the second region, and the third region.

The image of interest receiver 116 of the third image processing apparatus 110e receives the images of the fourth region and the fifth region, and decompresses the images when the received images are compressed. The information generator 118 of the third image processing apparatus 110e generates the necessary information by synthesizing the images of the fourth region and the fifth region.

The information generated by the second image processing apparatus 110c and the third image processing apparatus 110e may be used for various purposes, such as a driver's convenience, provision of driving information on the vehicle, safe driving assistance for the vehicle, or prevention of an accident.

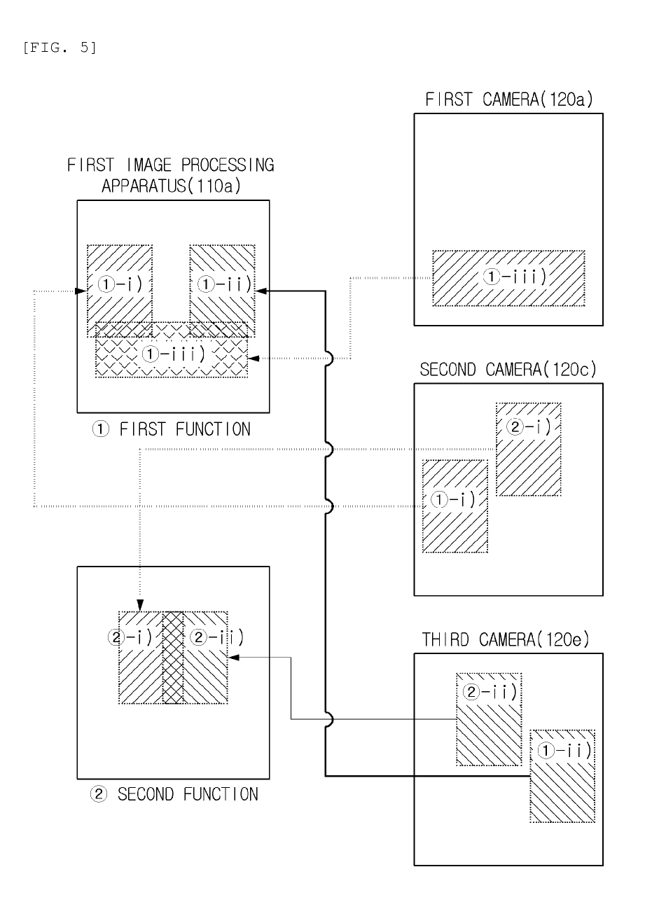

FIG. 5 is a diagram of yet another example in which a vehicle image processing system according to the present invention is used.

Referring to FIG. 5, a vehicle image processing system 100 includes one vehicle image processing apparatus 110 and three cameras 120.

The one vehicle image processing apparatus 110 is referred to as a first image processing apparatus 110a, and the first image processing apparatus 110a has two functions or purposes. That is, the first image processing apparatus 110a may generate two pieces of necessary information and set two different regions of interest.

A first function of the two functions is expressed as a first function, and a second function is expressed as a second function.

The region of interest setter 112 of the first image processing apparatus 110a may set a region of interest for the first function and another region of interest for the second function. The region of interest for the first function and another region of interest for the second function may partially overlap.

When the region of interest setter 112 of the first image processing apparatus 110a sets the region of interest for the first function and another region of interest for the second function, the region of interest setter 112 of the first image processing apparatus 110a may set a region of interest for each camera 120.

The first camera 120a, the second camera 120c, and the third camera 120e receive information on the region of interest from the first image processing apparatus 110a, and extract parts corresponding to the received region of interest from the photographed images. Each camera 120 transmits an image of the extracted part corresponding to the region of interest to the first image processing apparatus 110a. When each camera 120 transmits the image, the camera 120 may transmit information including time information for synchronization.

The first image processing apparatus 110a receives the image of the part corresponding to the region of interest from each camera 120, and generates the necessary information by synthesizing the image.

The two functions of the first image processing apparatus 110a may be performed at the same time, but may be performed at different times. When the two functions of the first image processing apparatus 110a are performed at the same time, the region of interest transmitter 114 of the first image processing apparatus 110a may transmit all of the region of interest for the first function and another region of interest for the second function to each camera 120. When the two functions of the first image processing apparatus 110a are performed at different times, the region of interest transmitter 114 of the first image processing apparatus 110a may transmit the region of interest for the corresponding performed function to each camera 120 only at a time at which the first function or the second function is performed. When the performance of the first function or the second function is stopped, the region of interest transmitter 114 of the first image processing apparatus 110a may transmit a signal instructing the stop of the transmission of an image related to a region of interest of a corresponding function to the camera 120.

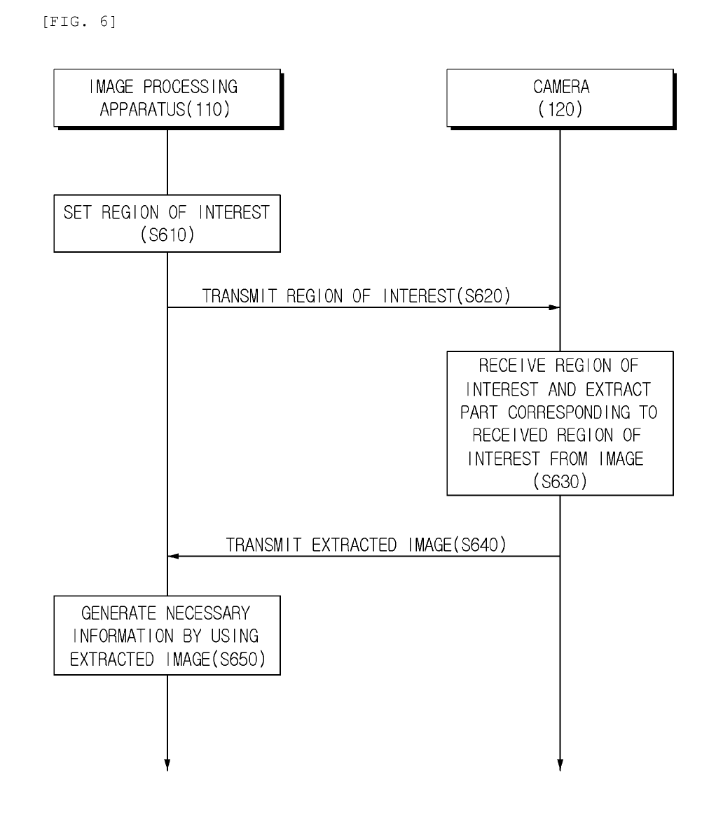

FIG. 6 is a flowchart illustrating a vehicle image processing method according to an exemplary embodiment of the present invention.

Referring to FIG. 6, the region of interest setter 112 sets a region of interest necessary for generating information (step S610).

The region of interest transmitter 114 transmits the set region of interest to the camera 120 (step S620).

The region of interest receiver 122 receives information on the region of interest transmitted by the region of interest transmitter 114, and the image extractor 124 extracts an image part corresponding to the region of interest received by the region of interest receiver 112 from an image photographed by the camera 120 (step S630).

The extracted image transmitter 126 transmits the image extracted by the image extractor 124 to the vehicle image processing apparatus 110 (step S640).

The image of interest receiver 116 receives the transmitted extracted image, and the information generator 118 generates information by using the received image (step S650).

It shall be understood that the block diagram of the vehicle image processing system 100 according to the exemplary embodiment of the present invention represents an exemplary conceptual point of view specifying a principle of the invention. Similarly, all of the flowcharts should be understood to be substantially expressed in computer-readable media and to express a variety of processes performed by a computer or a processor, regardless of whether the computer or the processor is clearly illustrated.

Functions of various devices illustrated in the drawings including functional blocks that are expressed as a processor or a concept similar thereto may be provided for use of dedicated hardware and use of hardware having a capability to execute software in association with appropriate software. When the functions are provided by the processor, the functions may be provided by a single dedicated processor, a single shared processor, or a plurality of individual processors, and a portion thereof may be shared.

Clear use of the processor, control, or terminology proposed as a similar concept thereto should not be interpreted by exclusively citing hardware having the capability to execute software, and should be understood to allusively include digital signal processor (DSP) hardware, ROM for storing software, RAM, and a non-volatile memory without restriction.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for processing an image of a vehicle, comprising:
a region of interest setter configured to set a region of interest that is a necessary region for generating specific information in images collected by cameras;
a region of interest transmitter configured to transmit information on the set necessary region to the cameras;
an image of interest receiver configured to receive images corresponding to the region of interest from the cameras; and
an information generator configured to generate information by using the image corresponding to the region of interest received by the image of interest receiver.

2. The apparatus of claim 1, wherein the number of cameras is at least two or more,
the region of interest setter sets the region of interest for each camera, and
the image of interest receiver receives only the images corresponding to the region of interest for the respective cameras among the images collected by the respective cameras from the respective cameras.

3. The apparatus of claim 2, wherein the information generator generates the information by synthesizing the images received by the image of interest receiver.

4. The apparatus of claim 1, wherein the image received by the image of interest receiver includes information on a time at which the camera collects the image.

5. The apparatus of claim 3, wherein the image received by the image of interest receiver includes information on a time at which the camera collects the image, and
the information generator synthesizes the images having the same information on a time included in the images among the received images when generating the information by synthesizing the received images.

6. The apparatus of claim 1, wherein the information generated by the information generator is at least one among lane departure information, an inter-vehicle distance from a front vehicle, information on a risk of forward collision with another vehicle or a pedestrian, high beam assist information, information on a neighboring area of a vehicle, information on backward parking assistance, and information on a following vehicle.

7. A system of processing an image of a vehicle, comprising:
at least one or more cameras configured to photograph an external side of a vehicle and collect image information; and
a vehicle image processing apparatus configured to transmit information on a necessary region among the image information collected by the camera to the camera.

8. The system of claim 7, wherein the camera comprises an image extractor configured to extract the information on the necessary region from the collected image information by using the information on the necessary region transmitted from the vehicle image processing apparatus.

9. The system of claim 8, wherein the camera further comprises an extracted image transmitter configured to transmit the image information extracted by the image extractor to the vehicle image processing apparatus, and
the vehicle image processing apparatus comprises an information generator configured to generate information by using the extracted image information.

10. The system of claim 8, wherein when the number of cameras is at least two or more, the vehicle image processing apparatus transmits information on each necessary region to each of the cameras,
each of the cameras extracts the image of the necessary region from the respective collected image information by using the respective received information on the necessary region and transmits the extracted image to the vehicle image processing apparatus, and
the vehicle image processing apparatus generates information by synthesizing the extracted image information.

11. The system of claim 7, wherein the vehicle image processing apparatus provides the information on the necessary region among the image information collected by the camera periodically, aperiodically, or once.

12. A method of processing an image of a vehicle, comprising:
a region of interest setting operation of setting information on a necessary region among images collected by cameras;
a region of interest transmitting operation of transmitting information on the set necessary region to the cameras;
an image extracting operation of extracting an image corresponding to the set necessary region from the images collected by the cameras;
an image of interest receiving operation of receiving the extracted images from the cameras; and
an information generating operation of generating information by using the images received in the image of interest receiving operation.

13. The method of claim 12, wherein the number of cameras is at least two or more,
in the region of interest setting operation, the information on the necessary region is set for each camera, and
in the image of interest receiving operation, only an image of the necessary region for each camera among the images collected by the respective cameras is received from each of the cameras.

14. The method of claim 13, wherein in the information generation operation, the information is generated by synthesizing the images received in the image of interest receiving operation.

15. The method of claim 12, wherein the image received in the image of interest receiving operation includes information on a time at which the camera collects the image.

16. The method of claim 14, wherein the image received in the image of interest receiving operation includes information on a time at which the camera collects the image, and
in the information generating operation, when the information is generated by synthesizing the received images, the images having the same information on a time included in the images among the received images are synthesized.
